(19) United States
(12) Patent Application Publication
(10) Pub. No.: US 2012/0116802 A1
(43) Pub. Date: May 10, 2012

(54) METHOD FOR ESTABLISHING A CONNECTION BETWEEN STEM-CELL SAMPLING AND A HEALTH SAVINGS FINANCIAL PRODUCT

(76) Inventor: Didier Nouzies, Gournay sur Marne (FR)

(21) Appl. No.: 13/380,682

(22) PCT Filed: Jun. 11, 2010
(86) PCT No.: PCT/FR2010/000428

§ 371 Date: Dec. 23, 2011

(30) Foreign Application Priority Data
Jun. 24, 2009 (FR) 09/03052

(51) Int. Cl. G06Q 50/22

(52) U.S. Cl. 705/2

(57) ABSTRACT

The present invention relates to a method of establishing a connection between a collection of stem cells taken from parturient women and a health savings financial product, the method consisting, in a first step in an “entity” body corporate proposing an option to the parturient woman to contract a financial product in the name of a beneficiary, herself or the newborn baby, which financial product includes an advantage in kind, being constituted by the stem cells taken at the time of birth, in taking a biological collection of placental tissues containing stem cells from the parturient woman, in sharing the tissue between two biocollections A and B that are entrusted to an entity, each of the two biocollections being accompanied by a respective data medium encoding an administrative, medico-technical, biological, medical, and financial management cycle specific to the biocollection. Subsequent steps complete the method.

The present invention relates to a method of establishing a connection between a stem cell collection and a health savings financial product for the purpose of protecting the health both of individuals and families on a private basis and also of the population at large on a general and solidarity basis, in particular by optimizing the development of offers of care on the basis of elements derived from the human body.

At present, it is very well known that hematopoietic stem cells (HSC) contained in placental cord blood (so-called placental blood units (pbu)) are very effective, essentially in terms of treating diseases of the bone marrow and of the blood.

It is also known that numerous non-hematopoietic stem cells of various types are present in the afterbirth (so-called placental tissue units (ptu)) such as the cord itself (essentially Wharton's jelly) and the placenta in particular, whereas cord blood in itself contains relatively few. Scientific authorities believe that non-hematopoietic cells have a great future in regenerative medicine and in cell therapy, and amongst these, there are particularly great hopes concerning mesenchymatous stem cells (MSC).

Although numerous public and private cord blood banks exist throughout the world (where public banks are free and for allogeneic purposes, and where private banks are paid-for and for family purposes, with private banks being paid 1500 euros to 4000 euros, depending on the country, for 15 to 20 years of conservation in a cryogenic bank), it would appear that at present there does not exist any private or public system that offers the following to a parturient woman: firstly private conservation of a portion of the tissues taken from her afterbirth at the time of birth (such as the cord and the placenta), secondly donation in parallel of cord blood to a public bank, and finally, thirdly performance of these two processes not by requesting the parturient woman to pay for a service (and thus at her expense and without security), but rather by proposing that she invest an equivalent sum in a savings entity that is dedicated to biomedicine (and thus providing financial interest or return and consideration recoverable as assets). By way of example, the property rights representative of this investment could be as follows: a simple or composite bond, a share, a share in investment funds (invested in bonds, in a variety of certificates of deposit, in shares, or in a mixture thereof), a regulated savings product.

However, a system having those characteristics would be much better at satisfying both technically and economically the needs of medico technical systems and research systems such as envisaged by specialists for the biomedicine of the future.

Firstly, placental blood is made available to the general population since it essentially contains hematopoietic stem cells that, in practice, are usually un-suitable for autologous usage (since potentially carrying the genetic defect that has given rise to the illness) or of therapeutic use that is too far away in time (since apart from those pathologies that occur in very young children, the great majority of pathologies of the blood usually occur after age 50, i.e. after a duration that is much too long for the visibility that is available for efficient and reliable cryo-conservation of pbu).

Secondly, the other placental tissues stemming from birth are for use by the person herself and by her baby (or her family) since such tissues are much too rich in cells of non-hematopoietic origin, particularly but not only mesenchymatous tissues, and they are more suitable for future use in cell therapy and in regenerative or reparative medicine.

Such a system would thus satisfy equally the requirements of the present and the promises of the future, while being based on means suitable for financing it (in particular, financing of the entire medico-technical process of collecting tissue, of pre-conservation biological analysis and treatment, of conservation, and of post-extraction biological analysis and treatment).

A process for making investments profitable is possible and economically viable, specifically because the therapeutic or biomedical stakes of the present and of the near future confer an exchange value on treated and characterized stem cells that is already high (pbu) with this applying even though the offer in terms of high quality biomedically approved pbu has little chance of being able to satisfy demand on a global scale: indications are ever increasing, in particular for adult populations with so-called “double” umbilical cord transplants.

When considering therapeutic applications that are hoped for and expected in the future, the property whereby ptu stem cells can be diverted to a very great variety of cell types of mesodermic, ectodermic, or endodermic origin, which property they share in part with embryonic stem cells (ESC) which are well-known as an eminently sensitive issue, gives them a central role in the targeted perspectives of regenerative medicine. The economic repercussions of such perspectives are potentially very great and ptu and pbu should constitute the cornerstone of those perspectives.

It is highly probable that cells collected today will provide the basis for biotreatments of tomorrow. Already, it is highly likely that within five years, the first clinical results could be available, e.g. concerning pathologies such as those associated with the functioning of the liver and with diabetes (pancreatic islets), based on taking stem cells present in ptu.

More precisely, the preservation provides a method of establishing a connection between stem cells taken from certain parturient women and a health savings financial product, a financial instrument representative of credit or capital, the method consisting:
in a first step:
   in that a body corporate referred to as an “entity” offers the parturient woman the option to contract a structured financial product in the name of a beneficiary selected from one of the following people: the parturient woman and the newborn baby; the financial product having as its main characteristic being associated with an advantage in kind consisting in at least one right including collecting, processing, and conserving stem cells taken from said parturient woman at the time of birth;
   taking from the parturient woman at the time of birth a biological tissue collection containing stem cells;
   sharing said biological tissue collection between two distinct biocollections A and B: the biocollection A being constituted mainly by at least a portion of the tissues taken during birth from the afterbirth and selected from the following tissues: placenta, umbilical cord, amnion, blood vessels irrigating these various tissues, amniotic liquid; the biocollection B being constituted mainly by placental cord blood taken from the umbilical cord while taking care to clamp said umbilical cord at its end as close as possible to the newborn baby;
   after performing biological analysis and treatment and then cryobiological preparation specifically adapted to cryoconservation of each of said two biocollections, placing the two biocollections A and B in two distinct medical packages, respectively E and E′, adapted to long-term cryogenic conservation of the two biocollections;
   determining data and instructions for a cycle of managing at least one of the following processes: administrative, medico-technical, biological, medical, and financial, relating to at least one of the biocollections from biocollection A and biocollection B;
   transforming these data and instructions into a series of computer signals;
   recording these computer signals in a permanent memory arranged on at least one of media S and S′;
   associating at least one of said media S and S′ with said medical packages, respectively E and E′; and
   in that the parturient woman donates these two assemblages (A, E, S) and (B, E′, S′) to an entity that stores them in at least one cryogenic vessel;
in a second step:
   in that the parturient woman proceeds to subscribe to said structured financial product associated with two dematerialized options as rights, one said option being private and the other said option being public, corresponding exactly with the two biocollections A and B of stem cells held by the entity;
   in that the private option is reallocated by the entity to the beneficiary as an advantage in kind associated with the subscribed financial product, which private option consists in at least a right of private ownership, of treatment, and of conservation of the biocollection A with a cryogenic conservation bank operator for a certain period;
   in that the public option is conserved by the entity, said public option consisting in at least a right of ownership, of treatment, and of conservation of the biocollection B with a cryogenic conservation bank operator during a certain period; and
   in that an organized dematerialized procedure enables the public options to be subjected to at least one of the following actions: acquisition, transfer, and exchange, by “health establishments” approved for that purpose;
in a third step:
   in the event of a private specific medical indication at least within the family, in that the beneficiary may, on exercising the private option, have the biocollection A of stem cells made available to the beneficiary, the competent medical authorities then being authorized:
   to cause the assemblage (A, E, S) to be extracted from the cryogenic vessel in which it is conserved;
   to separate the medium S from said medical package E and place said medium S so that its data can be read by means of a computer system;
   to program the programming unit of said computer system using the computer data stored on said medium S; and
   to cause said computer system to be operated firstly to personalize the management of at least one of the following processes: medico-administrative formalities, thawing, post-thawing biological treatment and preparation, stem cell isolation, stem cell characterization, expansion of stem cells in culture, and secondly to take account of and implement the contractual undertakings associated with the financial product, the stem cells derived from biocollection A being suitable at least for being transfused, transplanted, or used at the end of said cycle for therapeutic purposes in at least one of the following manners: autologous, related allogeneic; and the financial product being updated and set in such a manner as to enable it thereafter at least to be reimbursed to its beneficiary if that is requested;
in the event of a health establishment holding a public option, in that the establishment, on exercising said public option, may have the biocollection B of stem cells made available thereto, being authorized:
   to cause the assemblage (B, E′, S′) to be extracted from the cryogenic vessel in which it is conserved;
   to separate the medium S′ from said medical package E′ and place said medium S′ so that its data can be read by a computer system of the health establishment;
   to program the programming unit of said computer system of the health establishment using the computer data stored on said medium S′; and
   to cause said computer system of the health establishment to operate to take account of all of the medico-administrative, medico-technical, and biological data and instructions suitable for use in an appropriate and risk-free use of the biocollection B in at least one of the following purposes: unrelated allogeneic therapy, research, industrial preparation of therapeutic doses of “medicine cells”.

According to another characteristic of the present invention, prior to the two biocollections A and B being initially placed in the medical packages E and E′, they are subjected to biological examinations and analyses, and to specific biological treatments in order to make the two biocollections A and B suitable for medical use, at least for one of the following purposes: autologous and related allogeneic purposes for biocollection A, and at least to one of the following purposes: unrelated allogeneic purposes and industrial production of therapeutic doses of “medicine cells” including at least one immunosuppressant treatment, concerning biocollection B.

According to another characteristic of the present invention, at least biocollection A, that is for medical use in at least one of the following manners: autologous, related allogeneic, includes at least one of the following elements: a portion of the placental cord blood taken from the umbilical cord at the time of birth, and the biocollection B, that is for unrelated allogeneic medical use includes at least a portion of tissues taken during birth from the afterbirth and constituted by at least one of the following elements: placenta, umbilical cord, amnion, blood vessels irrigating these various tissues, amniotic liquid.

According to another characteristic of the present invention, at least for one of the biocollections from biocollection A and biocollection B, prior to cryogenically freezing the biocollection there is performed at least one of the procedures for isolating stem cells, for characterizing stem cells, and for expanding stem cells in culture, the stem cells being taken from at least part of said biocollection, and the respective biological results of performing the procedure(s) are associated with said biocollection in question in order to be cryogenically frozen.

According to another characteristic of the present invention, the financial product involved includes a right of substitution enabling the parturient woman, in the event of her not paying her subscription, to be in a position to be substituted by a saver who is not a tissue donor and who is a candidate for subscribing to an underlying instrument of the financial product without option, the beneficiary then holding the private option in kind giving a right to the biocollection A containing the stem cells.

According to another characteristic of the present invention, said media S and S′ are constituted by plates of plastics material and the permanent memory means are constituted by one of the following means: a unidimensional optical track, a bidimensional optical matrix, a magnetic track, laser etching, a holographic memory, an electronic chip.

According to another characteristic of the present invention, at least one of the media among the medium S and the medium S′ contains an electronic label coupled to a temperature sensor for measuring durations of time and possible temperature departures prior to storage in a cryogenic vessel, in order to store and transmit this data in real time to the computer system by a wireless communication channel, said data being routed to agents authorized to take emergency action in order to ensure that the cold chain is complied with.

According to another characteristic of the present invention, said plates of plastics material are made in a single operation in association with said medical packages and out of the same material.

According to another characteristic of the present invention, said plates of plastics material are separable from said packages by means of at least one of the following operations: pulling off, tearing, unsticking.

According to another characteristic of the present invention, the biocollection A from the biological tissue collection taken during birth is associated with at least one of the following biological elements taken from the beneficiary: cutaneous tissue, adipose tissue, teeth and in particular milk teeth and wisdom teeth, menstrual blood.

Other characteristics and advantages of the present invention appear from the following description given of an implementation of the method of the invention with a parturient woman.

From a biological and medical point of view, it is specified that the method of the invention has been designed from its initial conception to take into account around its core comprising a system based on placental tissue units (ptu) and on placental blood units (pbu), of subsequent generalized operational taking of ctu type tissue samples for autologous purposes (i.e. of cell or tissue units, such as cutaneous tissue, adipose tissue, teeth, and in particular milk teeth and wisdom teeth, and menstrual blood that can be added to the family's stored biological collection, should scientific progress make available the clinical potential thereof in terms of autologous cell therapy).

Expressed in the well-known terms of set logic, the following successive inclusions are defined concerning the various groups of tissues under consideration for implementing the method:

{pbu} AND {ptu}⊂{ctu}.

### IMPLEMENTATION OF THE METHOD

A married female person P is living with her husband and the couple, who are expecting a second child, wish to protect the future child from pathologies that may arise during the first 18 years of the child's life (up to majority). The couple are also interested in investing their savings in a financial product presenting a level of risk that may be said to be low, while also contributing to the principle of solidarity (public donation).

This person has heard of public and private financial investments arrangements that makes it possible to benefit from such a service by using the present method.

### Example of the Sequence of Operations for the Parturient Woman P:

This may consist:

Initially in offering this married woman P, if she so desires, the option to contract a financial product that actually becomes effective at the time of birth with the taking of a biological collection of ptu type placental tissues (thus including, particularly but not exclusively, samples of placental fractions of umbilical cord, of the amnion, of the blood vessels irrigating these various tissues), together with placental cord blood—pbu—contained in the umbilical cord connecting the mother to the child, after which, the tissue that has been taken is shared between a biocollection A belonging to the woman P and another biocollection B belonging to the public, both biocollections being for conserving in cryogenic banks or within biological resource centers, with this action being manifested by a set of administrative, technical, computer, and logistic procedures and formalities referred to as “pre-subscription”. At this stage, the organization offering to make said financial product contract (a health authority or any other approved legal entity) determines an identifier and a contract number, and where appropriate characteristics and/or instructions concerning the administrative and technical implementation of the financial product concerning the use of the private biocollection A.

At the time of birth, the sequence consists in taking samples of ptu/pbu placental tissues, and advantageously analyzing these tissues, or having them analyzed immediately after they have been taken, in order to determine whether they are suitable for subsequent medical use or research (for example virological and serological tests in addition to those that have already been performed on the mother, aerobic and anaerobic microbiological tests, flux cytometry viability measurements, various functional evaluations, and where appropriate: counting the number of cells, the concentration of stem cells, evaluating the various qualities of cells, possibly isolating them, characterizing them, and performing other validations and tests of a biological and medical nature), which process may be encumbant on or be shared with the economic entity constituting the conservation bank or an independent laboratory, in a procedure prior to separating and freezing the ptu/pbu.

If the tissue present in the ptu and the pbu is mostly or completely unsuitable for therapeutic use, that might fall within a clause for blocking the procedure for subscribing to the financial product before it becomes effectively activated with the lead investment bank and the issuer, it being possible for the procedure for subscribing to the financial product to be stopped at this point under such circumstances.

If the tissue is mostly or entirely suitable for therapeutic use, it is explained below how the parturient woman P may, as from the date of the samples being taken, have a first given time period (relatively short, measured in weeks) for actually taking out the subscription to the financial product, administratively speaking, followed by another time period referred to as a “latency” period (relatively long, measured in months) for confirming the subscription by paying the nominal amount of the subscription with the establishment specified by the entity issuing the financial product or a bank issuing the investment.

Thereafter, so far as P is concerned, the ptu and the pbu that have been taken are indeed divided into two biocollections A and B. The first biocollection (referred to as the family or private or A biocollection) is constituted mainly by tissue or tissue extract extracted from the afterbirth taken at the time of birth such as the umbilical cord (mainly Wharton's jelly) and placental fractions, and possibly also amnion, blood vessels irrigating these various tissues, and amniotic liquid, with this first biocollection possibly also advantageously including a minority portion of placental blood: this biocollection is for future autologous or related allogeneic use, and it is to be stored in nominative form in the private portion of a cryogenic conservation bank. The second biocollection (referred to as non-family or public or B biocollection) is constituted mainly by the placental cord blood taken from the umbilical cord, while taking care to clamp said umbilical cord at its end as close as possible to the newborn, for the purpose of maximizing the volume of blood that is collected, this second biocollection possibly also including “solid” elements of the afterbirth such as placental fractions or Wharton's jelly (the covering of the cord itself): this biocollection is for unrelated allogeneic use, it may possibly be made anonymous, and it is to be stored in the public portion of a cryogenic conservation bank or within an existing partner public bank.

After performing the biological analyses and treatments and then the cryobiological preparation that is specifically adapted to cryoconserving each of the two biocollections, the biocollections A and B are subsequently placed in two medical type packages: a package E for the biocollection A and a package E′ for the biocollection B. Where appropriate, these packages may be different, both in terms of the material used and of their shape. Since the biocollection A may contain a majority of solid biological material, its main package may be constituted by a rigid plastics material, whereas since the biocollection B mainly comprises the placental blood unit, and is thus of a liquid nature, it is more advantageously packaged in a main pouch of flexible plastics material of the kind already known for use in long-term cryogenic conservation of placental blood units or other substances derived from peripheral blood.

The proportions, and thus the biotechnical nature of this division of the initially-taken placental tissue into a biocollection A and a biocollection B are not “set in stone” and may vary or may constitute one of the dynamic variables of the method, the criterion being that this share-out should leave each of the two biocollections in a position to be reasonably usable for future medical use, for preparing therapeutic batches of “medicine cells”, or for research. Advantageously, and as already mentioned, biocollection A comprises a majority of tissues or tissue extracts that are of a so-called solid nature (such as: placenta, umbilical cord, amnion, blood vessels) rich in non-hematopoietic stem cells, while biocollection B mainly comprises the placental blood that is taken and that is rich in hematopoietic stem cells.

In the most advantageous implementation, before the two biocollections A and B are initially placed in the medical packages E and E′, they are subjected to biological analyses and examinations and to specific biological treatments that are already known to be essential at this stage in order to make both biocollections A and B suitable for subsequent therapeutic or medical use, i.e. for autologous or related allogeneic purposes concerning biocollection A, and for unrelated allogeneic purposes, thus including at least one immunosuppressor treatment—concerning the biocollection B.

Advantageously, as mentioned above, biocollection A, which is for autologous or related allogeneic medical use, may also include a minority portion of the placental cord blood taken from the umbilical cord at the time of birth, mainly because the technique for cellular expansion of HSC cells may be very significantly improved in the future. There is also an advantageous implementation that consists in these procedures for isolation/production and characterization of stem cells from all or part of the biocollections A and B to be performed, completely or in part, prior to cryogenic freezing of the biocollections, and for their respective biological results to be incorporated therewith before cryogenic freezing, and for this to be done as soon as possible (the biological optimum being within less than ten hours from taking the samples) in order to preserve the best possible health quality for the biological collection of stem cells made in this way.

Given its potentially large postoperative size, biocollection A may be subjected to and result from optional reductions, where appropriate, using techniques of the concentration, dissolution or dehydration, and desiccation type. It may also optionally be subdivided and compartmentalized depending on the types of tissue actually selected for conservation.

Thereafter, for storage of biocollection A in a cryogenic biobank, and after targeted and appropriate cryobiological treatment of said biocollection A, essentially for the purpose of enabling it to be preserved in the best possible manner given the possibly specific manner in which it is to be conserved, said biocollection A is inserted into the package E that is suitable for long-term cryogenic conservation, and biocollection A is associated with a computer data medium S having encoded thereon a data and instructions cycle concerning subsequent use of the biocollection for medico-administrative, medical, and therapeutic purposes, and also concerning implementing and updating data and instructions associated with the financial product stemming from the activation of said medical and therapeutic use, in particular an identifier or a contact number as previously generated and, where appropriate, characteristics or instructions relating to the operation of the financial product after the biocollection has been extracted from the conservation bank.

Once these data and instructions relating to biocollection A have been properly determined, setting software and/or hardware is used to insert and code them one or more times in a permanent memory placed on a medium. Naturally, the coding software and/or hardware is advantageously designed for use in a portable operation and transmission mode, using voice/data mobile wireless technologies for short range (WiFi, Bluetooth) or for long range (GSM, 3G, or indeed any other voice/data mobile telecommunications standard).

The data and instructions encoded to accompany biocollection A are very specific because of the very purpose and characterization of the method, nearly all of the tissue or tissue extract contained in biocollection A contains non-hematopoietic cells (in particular mesenchymatous cells) and is thus suitable for use in overall regenerative medicine in the future for the donor or for related individuals. In addition naturally to a unique biological identifier for the biocollection, the data and instructions may include, for example identity and administrative data concerning the parturient woman, the date and time the samples were taken, the physical characteristics of the various tissues in the biocollection, including dimensions or volume, weight, human leukocyte antigen (HLA) typing, the results of biological and serological tests, data concerning any hereditary diseases of the donor, coding of the various types of tissue concerned by the samples taken and the various identified stem cells, and any other medical or biological data deriving from analyses and treatments applied to biocollection A prior to cryogenic freezing. It is also possible to incorporate specific data, recommendations, or parameters that are deemed already to be of use in non-experimental manner in potential activation by the induced pluripotent stem cell (ips) induction technique of Prof. Yamanaka—2006 concerning certain categories or types of cells present in biocollection A. Naturally, memory segments that are extensive and not specifically allocated may be used for coding additional data of any kind, providing the data is usable and useful in post-extraction biological management and in therapeutic treatment that might be undertaken using biocollection A for autologous or related allogeneic purposes. Thus, advantageously and if the memory technology makes this possible, specific recommendations may be coded for thawing, possibly recommendations that are individualized depending on the biological content of biocollection A, which thawing is advantageously of the recommended “bain-marie” type or any other type of thawing technique known in the biomedical world or indeed a sequence of several such techniques with ordered coding of the successive steps and how they should progress over time in order to return to ambient temperature (or refrigerated transport), thus optimizing the preservation of cells in biocollection A as a function of the cryobiology used.

Now with reference to storing biocollection B in a cryogenic biobank, and after cryobiological treatment that is targeted and appropriate for this biocollection B that is essentially intended to be preserved in the best possible manner given the possibly specific way in which it is to be conserved, said biocollection B is inserted into the package E′ adapted to long-term cryogenic conservation, and the biocollection B is accompanied by a computer data medium S′ having coded thereon a data and instructions cycle concerning subsequent use of the biocollection for medical, pharmaceutical, or research purposes. If the biocollection B includes solid pbu portions, it may, like biocollection A, be subjected to optional subdivision and compartmentalization, depending on the types of tissue actually selected for conservation. The coding of the medium S′ of the biocollection B advantageously includes any characteristic data relating to all of the conserved tissue portions.

Once the data and instructions relating to biocollection B have been determined, setting software and/or hardware is used to insert and code them in a permanent memory placed on a medium. Naturally, this coding software and/or hardware is advantageously designed to use a portable operating and transmission mode making use of short-range or long-range mobile wireless technologies.

The data and instructions that are encoded to accompany biocollection B are specific to the fact that, by the very purpose and characterization of the method, the tissue or tissue extracts contained in biocollection B contain stem cells suitable for use by a population unrelated to the donor. Thus, mainly and by way of example, and naturally in addition to a unique identifier of the biocollection, the data and instructions include the date and place where the samples were taken, the physical characteristics of the pbu such as the volume of the solution possibly its weight, its HLA typing, the results of biological and serological tests, data about the hereditary diseases of the donor, if any, and more generally any other biological data derived from analyses and treatments applied to the biocollection B prior to cryogenic freezing. Extensive and not specifically allocated memory segments enable additional data to be coded, of any kind providing the data is usable and useful in post-extraction biological management and in the therapeutic treatment that might be carried out on this biocollection B for unrelated allogeneic purposes. Thus, advantageously and if the memory technology makes this possible, specific thawing recommendations should be encoded, possibly individualized to the liquid nature and to the biological content of the pbu forming part of the biocollection B, the thawing advantageously being of the recommended “bain-marie” type or any other type of thawing technique known in the biomedical world, or indeed a sequence of a plurality of such techniques with ordered coding of the successive steps and of their progress over time to return to ambient temperature (or refrigerated transport), thus enabling optimized cell preservation of the pbu of biocollection B as a function of the cryobiological that is specifically used.

For each of the two types of biocollection A and B, written recommendations and instructions may advantageously be printed directly on the packages E and E′ or indeed on the media S and S′, if that is technically possible, in order to guide the various operators and handlers who will be called on subsequently to handle them and to use them.

In an advantageous implementation, the coding media S and S′ are constituted by respective plates, e.g. cards or the like made of a material such as a plastics material that is advantageously fairly stiff, a metal sheet, or the like. These media, and the memory means that are placed thereon, and of course naturally the package, must be capable of conserving their properties and of remaining operational while being lowered to very low temperatures, e.g. in a liquid nitrogen atmosphere at approximately −196° C., or a gaseous nitrogen atmosphere at approximately −135° C., or indeed any other mode of cold conservation adapted to such long-term biological preservation. Concerning said permanent memory means, they may be constituted by any of the following means: a single or multi-dimensional optical track (optical matrix), a high coercitivity magnetic track, laser etching, holographic memory, or an electronic chip. These techniques are themselves well known and they are therefore not described in greater detail herein.

Thereafter:
concerning the medium S: the data and instructions relating to the cycle of managing at least one of the following steps: thawing, isolation/production of stem cells, characterization, culturing, expansion of stem cells, and means for managing and carrying out contractual undertakings associated with the subscription to the financial product such as an identifier or a contract number, and where appropriate characteristics concerning the implementation of the undertakings of the financial product post-extraction from the conservation bank; and
concerning the medium S′: the data and instructions relating to administrative, medico-technical, and biological management useful for appropriate risk-free use of biocollection B for unrelated allogeneic purposes or for industrial preparation of uniform therapeutic doses of “medicine cells”;
   are taken respectively from S and S′ and stored in memory.

The two permanent-memory and medium units are thus prepared and associated with the respective packages E and E′. Naturally, this association may be done in various ways. For example, a card may simply be fastened by glue or by an adhesive so as to enable it to be associated with the package and unstuck relatively easily therefrom when so desired, while still being capable of subsequently being stuck back on in reliable manner, in particular merely by pressing on the initial adhesion surface. It may also be placed in a pouch made for this purpose and associated with the package by any means. More advantageously, and for readily understood health security reasons, it may also be made in the material of the packaging itself, in a single operation while making said package. By way of example, under such circumstances, points of weakness may separate the plate proper from the package so that the plate can be separated fairly easily from said package, e.g. by being pulled off, torn, etc. The points of weakness may be perforations, a reduced thickness of material, etc.

It should naturally be understood that the above operations and handling may be performed in full or in part at any stage prior to cryogenic freezing, providing the biocollections in question comply with a maximum period prior to cryogenic freezing that is compatible with keeping an optimum quantity of cells alive and with known procedures for transport in biorefrigerated health mode. Thus, when the collection is made, an approved administrative bureau, an approved biomedical laboratory, and the cryogenic conservation bank may each be involved in full or in part in these handling and coding operations. It will be understood that if it is necessary to provide an optimized process of thawing in stages, which is consequently coded in the permanent memory arranged on a medium S or S′, then the entire stage of defining instructions and that of transforming and recording the corresponding instructions and indeed the stage of making up the assemblages (A, E, S) and (B, E′, S′) are more usefully performed by the conservation bank itself or in a laboratory in operating proximity with the cryogenic vessels.

At some given moment, these various operations and acts of handling will require isothermal packaging and conveying and will probably make use of refrigerated or similar modes of transport and vehicles, in particular for delivery to the conservation biobanks.

In an advantageous implementation, in order to improve the security of health transport of such assemblages having a very sensitive biological content, said assemblage(s) as conveyed in this way should be provided with respective electronic labels suitable for fastening on or being incorporated in said assemblages by means similar to those mentioned above for the connections between the packages and the media, such an electronic label being coupled in non-separable manner with a temperature sensor suitable for measuring the durations and any departures of temperature that take place during the period preceding storage in a cryogenic vessel, so as to store said data in memory or so as to transmit it in real time to the computer system using a wireless communication channel, said data being routed—by SMS or by email—where appropriate to agents entitled to take emergency action to ensure that the cold chain is complied with in the event of an interruption.

On receiving the assemblages and, where appropriate, after being involved in the operations of coding instructions and handling the assemblages, the biobanks can then store them in at least one cryogenic vessel designed for this purpose. To do this, and in a space that is as compact as possible given the type of assemblage be conserved, said assemblages (A, E, S) and (B, E′, S′) may themselves be put into respective optionally-metal boxes suitable for being stored in standardized and calibrated compartments in the cryogenic vessel(s) that may be specialized for this purpose.

Thereafter there follows dematerialization of the biological process:
Once the above points have been successfully completed in full or in part, and in correspondence with the number or contact identifier specific to the person P, she may subscribe to a financial product of the method with an issuer and within an administrative time period that is given and variable depending on the characteristics selected by the issuer and the lead investment bank (e.g. 1 month).
As from the date on which the ptu is taken, the donor-subscriber P may have a period of fixed duration (referred to as the “latency” period) to pay the subscription, from the beginning of which period there is automatically issued a subscription or substitution right (referred to below as “2SR”) on the financial product, a financial instrument of no or symbolic nominal value, the property of the donor-subscriber, and having a maximum lifetime equivalent to the latency period. This 2SR is exercisable automatically on payment of the nominal subscription amount for the financial product. It is specified that during the latency period, the lack of payment by the donor-subscriber does not in any way abridge her ownership rights over biocollection A (via the dematerialized option that is attached thereto).
If, during this latency period, the donor-subscriber is unable to pay the subscription, then the 2SR may be transferred by an intermediary procedure specifically created for this purpose, which intermediary procedure may be accessed indirectly by individual savers who are not necessarily ptu and pbu donors, via intermediaries appointed and approved for this purpose. If at the end of the latency period, the donor-subscriber has still not paid the subscription, and the 2SR has still not been effectively transferred by the subscriber, then the subscription to the financial product is closed and the biocollection A may, for example, be returned to the public domain.
The assignee of the 2SR becomes the proprietor of the financial product and thus takes the place of the donor concerning ownership of the financial product after paying the nominal amount therefor, it being specified that the assignor has no other rights that could be associated with the biomedical coupon and with the tissue samples associated with the financial product (in particular no rights on the option for therapeutic use of the private biocollection initially attached to the financial product, the collection remaining under the exclusive ownership of the donor-subscriber or of the designated beneficiary, with this applying regardless of whether the 2SR has been assigned). It is specified once more that the transfer of the 2SR is carried out advantageously at a value of zero in order to comply with the most widely accepted ethical principles.
For the person P, both biocollections A and B are dematerialized in the form of options referred to as therapeutic use options (“tuo”) that possess the following main characteristics:
   a family tuo (“ftuo”) associated with the private biocollection A that is either attached to the financial product after it has been paid for, if it is the donor-subscriber who owns the financial product, or else is detached therefrom and made independent, if the donor-subscriber has transferred her 2SR to a substitute saver during the latency period (under such circumstances the ftuo becomes independent but remains the property of the donor-subscriber). The ftuo may then be exercised at any moment by the donor-subscriber (decision subject to approval of a recognized medical authority, such use being associated with preventing, treating, or attenuating a severe pathology arising with the child or in the family of the donor-subscriber); it being specified that the decision to buy back (reimburse) the financial product, taking place at the end of a possible agreed blocking period, leaves the ftuo open and exercisable at any moment;
   a non-family tuo (“ntuo”) associated with the public biocollection B, made immediately independent and detached from the financial product. This ntuo is entrusted to a specialized and dedicated regulator entity (referred to as the regulator) that makes it available to dematerialized access using a dematerialized exchange, transfer, or acquisition procedure, or indeed a dematerialized exchange floor for these ntuo within an organization of legal entities that have previously been approved and authorized by the regulator for the purpose of receiving at least one or more bids for acquiring or transferring the biocollection (thus valued as a sample plus a biological added value conferred on said sample), or indeed in order to proceed with a swap.
The ftuo and ntuo options have a lifetime corresponding to the maturity date of the financial product, optionally plus an additional period, during which period they remain active (exercise and conservation in the biocollection) even though the financial product may in the meanwhile have been reimbursed or paid.
The regulator for regularity acquisition, transfer, and exchange of the ntuos public options approves and then accredits candidates for future acquisition of ntuo (and thus the corresponding biocollections for unrelated allogeneic purposes) within this dematerialized procedure: specifically, public or private hospital groups in countries adhering to the system, public or private biomedical research laboratories, industrial entities for producing batches of “medicine cells” (pharmaceutical industry), or more generally any body corporate entity serving the general interest in terms of human health.
As they are created, the ntuos are listed by the acquisition, transfer, or exchange procedure or they are listed on a dematerialized exchange floor open to said accredited users under the plenary authority of the regulator, on which floor each body corporate entity acting as a primary issuer of the financial product, and thus of the administered ntuos, is in a position to set a proposed acquisition value corresponding to the biological added value conferred on the biocollection and each accredited user can submit a transfer or acquisition bid or can propose a swap of ntuos.
These ntuos may advantageously be made available to or incorporated in the present computer infrastructure and network of the worldwide network for accrediting public cord blood banks known as NetCord®, or any other appropriate transnational structure, or indeed they may be the subject of a new and independent dematerialized procedure in private or grouped form.

Finally, when it is a question of using the biocollections of stem cells from the person P and stored in cryogenic banks in application of the method:
In the first situation of private use of biocollection A, on medical decision (in order to prevent a pathology, or more usually to treat or attenuate a pathology by means of an autologous transplant or a family allogeneic transplant), the ftou is exercised by the donor-subscriber P or by a designated beneficiary under the control of the medical authority that must implement prior activation of medical authorization for family use.
In the second circumstance of acquisition of a public option (ntuo), which has previously been acquired, transferred, or exchanged by an authorized health establishment, it may then be exercised at any time.

In the general situation (biocollections A and B), from a medico-technical and biological point of view, exercising options gives rise automatically, via the computer system and the network, to the conservation bank being warned, and consequently the biocollection is then liable to be extracted from the cryogenic vessel at any moment. Once all or part of the biocollection corresponding to the exercised tuo has been extracted from the vessel, the operator-handler reads directly or indirectly via the computer system the instructions and data mentioned on the package E or E′ (or on the accompanying medium S or S′) so as to enable best possible execution of the administrative, medico-technical, biological, medical, and financial preparation cycle. The computer system incorporates these instructions and data in its own local or central procedures and submits them to sequential verification by the operator-handler. As during the pre-conservation stage, it should naturally be understood that these post-extraction procedures calling on the computer system and on its decoding software and/or hardware should advantageously be designed in a portable operating and transmission mode making use of short- or long-range mobile wireless technologies.

By way of non-exclusive example, among the medico-technical and biological procedures that the method then makes it possible to activate, it is advantageously possible to implement the following procedure upstream from the biobank and assuming that it is managing the thawing of the biocollection in question: the operator-handler inserts the medium in the programming read input of the computer system to which the operator-handler has access, e.g. in order to transfer, into the memory of a local or remote central unit of the computer system, the data and instructions recorded in the memory of the medium and relating to the process for thawing in phases as is needed to obtain the best possible quality of cells. Naturally, this operation should most advantageously be performed by the operator-handler in a portable mode of operation and transmission of said computer system that makes use of short- or long-range voice/data mobile wireless technologies.

The operator-handler then runs the data and the appropriate program obtained in this way, said program possibly issuing alarm signals, depending on the data in the coded management cycle, in order to warn when the operator-handler needs to perform some specific operation, e.g. change a “bain-marie” during a stage of thawing in controlled and successive stages, or a biological purification procedure, etc. At the end of the management cycle, a specific signal or message informs the operator-handler that the biological preparation has passed all of the steps needed for best thawing. This type of procedure is the same at the other management steps that may be programmed for biocollections, in particular concerning the step of isolating/producing stem cells, e.g. with signals and physical actions performed by an operator-handler activating a purification selection method of the CD34 type as may be provided for in the management cycle present in the memory of the medium, or indeed at the step concerning possible cell expansion culturing by the signal given for passing from a stage of putting into culture to performing a known and ordered handling operation on said culture.

At any time, alert signals are always provided for warning of potential inconsistency in the data, which might have become partially obsolete since the biocollection in question was stored in the biobank, or indeed concerning incompatibility with the receiver candidate (for the unrelated allogeneic biocollection B)—assuming that the candidate is fully identified at this instant.

At the end of the general medico-technical, biological, and therapeutic management cycle, the stem cells have been characterized, produced, and/or multiplied/expanded, with all this being done under the legal authority of the donor-subscriber or the beneficiary if the beneficiary is of a legal age for doing so (biocollection A), or of the health establishment (biocollection B). With biocollection A, the biological preparation derived therefrom is then ready for medical use within the family of the donor-subscriber P. With biocollection B, the biological preparation derived therefrom is then ready for an unrelated allogeneic medical use, for preparing one or more therapeutic batches of “medicine cells”, or for research experimentation as provided for in the public health objectives specific to the acquiring establishment and duly declared as such to the regulator.

From a financial point of view, and specifically when concerning an extraction from a private type A biocollection, it is the health establishment or any administrative office approved for this purpose or the conservation bank itself as from the first procedure that it activates that makes use of the medium S and of the data and instructions coded in its permanent memory for implementing the operation of the financial product, with the help of the number or the contract identifier included in the memory and where appropriate with the help of financial characteristics and instructions that are also included therein, with this being done in accordance with the contract by programming and controlling the computer system. Under such circumstances, and as described above for the medico-technical and biological procedures, it is advantageous to make use of portable network and computer technologies.

### Contractual Characteristics Specific to the Parturient Woman P Concerning the Financial Coupling

By way of example, the solution of an exclusively private nature comprises a subscription to a financial product, on the basis of investment funds dedicated to the underlying bond-holder and providing for capitalization of interest up to the end of the so-called “blocking” period and annualization thereafter. Its fixed return may for example be 7% gross for the first two years and set thereafter at 4% with a tax-free net return over the entire duration to maturity at 18 years (legal age of majority for the child in numerous countries). This issue is carried out by a partnership between a private hospital organization operating on a national scale (the collecting operator) and a private biobank operator (the conservation operator) and for example benefits from oversight by a private health insurance group (the financial operator) concerning the financial aspects.

By way of example, the financial product may be called “intergenerational-solidarity-bond”. Merely by way of example, it might have the following characteristics from a financial point of view:

a) its maturity is at 18 years. It has an irreducible nominal amount of 2000 euros;

b) its current net return after 2 years elapsed is 4%, the first two years benefiting from a gross rate of 7% per annum;

c) the financial product is partially tax-free, for example being subjected to only one tranche of social security charges during the first two years and being completely tax-free thereafter; it is associated with the guarantee by the authorities of the country in which the issue takes place for up to 50% of the capital paid on subscription, assuming it exceeds the ceiling for legally guaranteed deposits and securities in said country;

d) in the event of a confirmed family therapeutic need (medical authority), the subscriber has the option to raise and then exercise the option to use the private biocollection. This automatically triggers prorata capitalization of interest at that time followed by reimbursement of the total amount of the financial product due to the subscriber;

e) if the option on the private ptu is not raised, then that option remains attached to the financial product and the amount thereof is blocked for a period of 8 years;

f) at the end of the blocked 8 years, the financial product is reimbursable merely on request by the subscriber, the private option then becoming independent and remaining acquired by the subscriber up to the maturity date (and biocollection A is naturally conserved);

g) once the biological sample has been taken successfully and found suitable in biomedical terms, each of the declared subscribers has a subscription or substitution right (2SR) allocated thereto having no nominal value and with a latency period of 1 year from the time of taking the sample for exercising it merely by subscribing to the 2000 euro nominal amount of the financial product. If during this latency period of one year, a family therapeutic use of biocollection A is found to be necessary (medical authority), then the donor benefits therefrom without any obligation to subscribe subsequently and without any extra cost—an “emergency therapy” clause;

h) during this latency period, the declared subscribers have the option to transfer the 2SR by activating a regulated interbank procedure dedicated for this purpose (in particular in the event of insufficient financial resources) so that a non-donor candidate saver can benefit therefrom, can exercise it, and consequently can subscribe to the underlying financial product;

i) the use options on the public biocollections (biocollection B), all made fully independent as soon as the financial product is subscribed, may be acquired or exchanged by body corporate entities operating in the medical, biomedical, and pharmaceutical fields, in a market that is closed, regulated, and strictly controlled as to gaining access thereto.

Whatever the technical, biomedical and medical, logistic, or financial elements that are used by the method, its technical implementation is advantageous since by means of the interactions it provides it makes it possible to better optimize, reliabilize, and specialize various care techniques from human body elements in the medium or long term as a function of the types of stem cells that are most specifically appropriate for a given pathology or medical purpose (autologous or heterologous). The method thus makes it possible automatically to obtain the best possible use of stem cells, both for private purposes (family) and for public and solidarity purposes (non-family), with quality that comes as close to possible to use that could be made immediately after taking the samples (i.e. without going through the stage of cryogenically freezing the cells). Finally, the method enables all of the medico-technical process for developing care from human body elements to organize its overall self-financing (collection, pre-conservation biological analysis and treatment, conservation, post-extraction biological analysis and treatment, preparation of therapeutic batches of uniform quality, research).

1. A method of establishing a connection between stem cells taken from certain parturient women and a health savings financial product, a financial instrument representative of credit or capital, the method consisting:
in a first step:
in that a body corporate referred to as an “entity” offers the parturient woman the option to contract a structured financial product in the name of a beneficiary selected from one of the following people: the parturient woman and the newborn baby; the financial product having as its main characteristic being associated with an advantage in kind consisting in at least one right including collecting, processing, and conserving stem cells taken from said parturient woman at the time of birth;
taking from the parturient woman at the time of birth a biological tissue collection containing stem cells;
sharing said biological tissue collection between two distinct biocollections A and B: the biocollection A being constituted mainly by at least a portion of the tissues taken during birth from the afterbirth and selected from the following tissues: placenta, umbilical cord, amnion, blood vessels irrigating these various tissues, amniotic liquid; the biocollection B being constituted mainly by placental cord blood taken from the umbilical cord while taking care to clamp said umbilical cord at its end as close as possible to the newborn baby;
after performing biological analysis and treatment and then cryobiological preparation specifically adapted to cryoconservation of each of said two biocollections, placing the two biocollections A and B in two distinct medical packages, respectively E and E′, adapted to long-term cryogenic conservation of the two biocollections;
determining data and instructions for a cycle of managing at least one of the following processes: administrative, medico-technical, biological, medical, and financial, relating to at least one of the biocollections from biocollection A and biocollection B;
transforming these data and instructions into a series of computer signals;
recording these computer signals in a permanent memory arranged on at least one of media S and S′;
associating at least one of said media S and S′ with said medical packages, respectively E and E′; and
in that the parturient woman donates these two assemblages (A, E, S) and (B, E′, S′) to an entity that stores them in at least one cryogenic vessel;
in a second step:
in that the parturient woman proceeds to subscribe to said structured financial product associated with two dematerialized options as rights, one said option being private and the other said option being public, corresponding exactly with the two biocollections A and B of stem cells held by the entity;
in that the private option is reallocated by the entity to the beneficiary as an advantage in kind associated with the subscribed financial product, which private option consists in at least a right of private ownership, of treatment, and of conservation of the biocollection A with a cryogenic conservation bank operator for a certain period;
in that the public option is conserved by the entity, said public option consisting in at least a right of ownership, of treatment, and of conservation of the biocollection B with a cryogenic conservation bank operator during a certain period; and
in that an organized dematerialized procedure enables the public options to be subjected to at least one of the following actions: acquisition, transfer, and exchange, by “health establishments” approved for that purpose;
in a third step:
in the event of a private specific medical indication at least within the family, in that the beneficiary may, on exercising the private option, have the biocollection A of stem cells made available to the beneficiary, the competent medical authorities then being authorized:
to cause the assemblage (A, E, S) to be extracted from the cryogenic vessel in which it is conserved;
to separate the medium S from said medical package E and place said medium S so that its data can be read by means of a computer system;
to program the programming unit of said computer system using the computer data stored on said medium S; and
to cause said computer system to be operated firstly to personalize the management of at least one of the following processes: medico-administrative formalities, thawing, post-thawing biological treatment and preparation, stem cell isolation, stem cell characterization, expansion of stem cells in culture, and secondly to take account of and implement the contractual undertakings associated with the financial product, the stem cells derived from biocollection A being suitable at least for being transfused, transplanted, or used at the end of said cycle for therapeutic purposes in at least one of the following manners: autologous, related allogeneic; and the financial product being updated and set in such a manner as to enable it thereafter at least to be reimbursed to its beneficiary if that is requested;
in the event of a health establishment holding a public option, in that the establishment, on exercising said public option, may have the biocollection B of stem cells made available thereto, being authorized:
to cause the assemblage (B, E′, S′) to be extracted from the cryogenic vessel in which it is conserved;
to separate the medium S′ from said medical package E′ and place said medium S′ so that its data can be read by a computer system of the health establishment;
to program the programming unit of said computer system of the health establishment using the computer data stored on said medium S′; and
to cause said computer system of the health establishment to operate to take account of all of the medico-administrative, medico-technical, and biological data and instructions suitable for use in an appropriate and risk-free use of the biocollection B in at least one of the following purposes: unrelated allogeneic therapy, research, industrial preparation of therapeutic doses of “medicine cells”.

2. A method according to claim 1, characterized by the fact that prior to the two biocollections A and B being initially placed in the medical packages E and E′, they are subjected to biological examinations and analyses, and to specific biological treatments in order to make the two biocollections A and B suitable for medical use, at least for one of the following purposes: autologous and related allogeneic purposes for biocollection A, and at least to one of the following purposes:
unrelated allogeneic purposes and industrial production of therapeutic doses of “medicine cells” including at least one immunosuppressant treatment, concerning biocollection B.

3. A method according to claim 1, characterized at least by the fact that biocollection A, that is for medical use in at least one of the following manners: autologous, related allogeneic, includes at least one of the following elements: a portion of the placental cord blood taken from the umbilical cord at the time of birth, and by the fact that the biocollection B, that is for unrelated allogeneic medical use includes at least a portion of tissues taken during birth from the afterbirth and constituted by at least one of the following elements: placenta, umbilical cord, amnion, blood vessels irrigating these various tissues, amniotic liquid.

4. A method according to claim 1, characterized by the fact that at least for one of the biocollections from biocollection A and biocollection B, prior to cryogenically freezing the biocollection there is performed at least one of the procedures for isolating stem cells, for characterizing stem cells, and for expanding stem cells in culture, the stem cells being taken from at least part of said biocollection and the respective biological results thereof are associated with said biocollection in question in order to be cryogenically frozen.

5. A method according to claim 1, characterized by the fact that the financial product involved includes a right of substitution enabling the parturient woman, in the event of her not paying her subscription, to be in a position to be substituted by a saver who is not a tissue donor and who is a candidate for subscribing to an underlying instrument of the financial product without option, the beneficiary then holding the private option in kind giving a right to the biocollection A containing the stem cells.

6. A method according to claim 1, characterized by the fact that said media S and S′ are constituted by plates of plastics material and the permanent memory means are constituted by one of the following means: a unidimensional optical track, a bidimensional optical matrix, a magnetic track, laser etching, a holographic memory, an electronic chip.

7. A method according to claim 1, characterized by the fact that at least one of the media among the medium S and the medium S′ contains an electronic label coupled to a temperature sensor for measuring durations of time and possible temperature departures prior to storage in a cryogenic vessel, in order to store and transmit this data in real time to the computer system by a wireless communication channel, said data being routed to agents authorized to take emergency action in order to ensure that the cold chain is complied with.

8. A method according to claim 6, characterized by the fact that said plates of plastics material are made in a single operation in association with said medical packages and out of the same material.

9. A method according to claim 8, characterized by the fact that said plates of plastics material are separable from said packages by means of at least one of the following operations: pulling off, tearing, unsticking.

10. A method according to claim 1, characterized by the fact that the biocollection A from the biological tissue collection taken during birth is associated with at least one of the following biological elements taken from the beneficiary: cutaneous tissue, adipose tissue, teeth and in particular milk teeth and wisdom teeth, menstrual blood.

11. A method according to claim 2, characterized at least by the fact that biocollection A, that is for medical use in at least one of the following manners: autologous, related allogeneic, includes at least one of the following elements: a portion of the placental cord blood taken from the umbilical cord at the time of birth, and by the fact that the biocollection B, that is for unrelated allogeneic medical use includes at least a portion of tissues taken during birth from the afterbirth and constituted by at least one of the following elements: placenta, umbilical cord, amnion, blood vessels irrigating these various tissues, amniotic liquid.

12. A method according to claim 2, characterized by the fact that at least for one of the biocollections from biocollection A and biocollection B, prior to cryogenically freezing the biocollection there is performed at least one of the procedures for isolating stem cells, for characterizing stem cells, and for expanding stem cells in culture, the stem cells being taken from at least part of said biocollection and the respective biological results thereof are associated with said biocollection in question in order to be cryogenically frozen.

13. A method according to claim 3, characterized by the fact that at least for one of the biocollections from biocollection A and biocollection B, prior to cryogenically freezing the biocollection there is performed at least one of the procedures for isolating stem cells, for characterizing stem cells, and for expanding stem cells in culture, the stem cells being taken from at least part of said biocollection and the respective biological results thereof are associated with said biocollection in question in order to be cryogenically frozen.

14. A method according to claim 2, characterized by the fact that the financial product involved includes a right of substitution enabling the parturient woman, in the event of her not paying her subscription, to be in a position to be substituted by a saver who is not a tissue donor and who is a candidate for subscribing to an underlying instrument of the financial product without option, the beneficiary then holding the private option in kind giving a right to the biocollection A containing the stem cells.

15. A method according to claim 3, characterized by the fact that the financial product involved includes a right of substitution enabling the parturient woman, in the event of her not paying her subscription, to be in a position to be substituted by a saver who is not a tissue donor and who is a candidate for subscribing to an underlying instrument of the financial product without option, the beneficiary then holding the private option in kind giving a right to the biocollection A containing the stem cells.

16. A method according to claim 4, characterized by the fact that the financial product involved includes a right of substitution enabling the parturient woman, in the event of her not paying her subscription, to be in a position to be substituted by a saver who is not a tissue donor and who is a candidate for subscribing to an underlying instrument of the financial product without option, the beneficiary then holding the private option in kind giving a right to the biocollection A containing the stem cells.

17. A method according to claim 2, characterized by the fact that said media S and S′ are constituted by plates of plastics material and the permanent memory means are constituted by one of the following means: a unidimensional optical track, a bidimensional optical matrix, a magnetic track, laser etching, a holographic memory, an electronic chip.

18. A method according to claim 3, characterized by the fact that said media S and S′ are constituted by plates of plastics material and the permanent memory means are constituted by one of the following means: a unidimensional optical track, a bidimensional optical matrix, a magnetic track, laser etching, a holographic memory, an electronic chip.

19. A method according to claim 4, characterized by the fact that said media S and S′ are constituted by plates of plastics material and the permanent memory means are constituted by one of the following means: a unidimensional optical track, a bidimensional optical matrix, a magnetic track, laser etching, a holographic memory, an electronic chip.

20. A method according to claim 5, characterized by the fact that said media S and S′ are constituted by plates of plastics material and the permanent memory means are constituted by one of the following means: a unidimensional optical track, a bidimensional optical matrix, a magnetic track, laser etching, a holographic memory, an electronic chip.
